(19) United States
(12) Patent Application Publication
(10) Pub. No.: US 2012/0060087 A1
(43) Pub. Date: Mar. 8, 2012

(54) SYSTEM AND METHOD FOR CONVERTING AN EXISTING WEBSITE INTO A MOBILE COMPATIBLE WEBSITE

(76) Inventors: Mohamad Jame, Irvine, CA (US); Jason Charles Pammer, Tustin, CA (US)

(21) Appl. No.: 13/224,595

(22) Filed: Sep. 2, 2011

Related U.S. Application Data
(60) Provisional application No. 61/379,649, filed on Sep. 2, 2010.

(51) Int. Cl. G06F 17/00

(52) U.S. Cl. 715/238

(57) ABSTRACT

A system and method for converting an existing website into a mobile compatible website includes a size identification module that identifies a desired mobile display size which is suitable for the mobile device; a website identification interface that identifies an original website having an original display size that is larger than the desired mobile display size; a website retrieval interface that retrieves an original content of the original website; a parsing module that parses the original content to identify website elements to be resized; a resizing module that provides a mobile content having resized elements that correspond to the elements-to-be-resized and which are adapted for display utilizing the desired mobile display size; a website generation module that generates a second website having the mobile content; and a website serving interface that provides the second website to the mobile device.

### RELATED APPLICATIONS

This application claims the benefit of the filing date of U.S. Patent Application No. 61/379,649, filed Sep. 2, 2010, which is incorporated herein by reference in its entirety.

### BACKGROUND OF THE INVENTION

The present invention generally relates to tools for converting and viewing data, and more specifically to a system and method for converting an existing website into a mobile compatible website.

In order to have a mobile friendly website, different means exists, but are not adapted to smartphone standards of quality. Market available solutions are obsolete and do not provide automatically the end-users to perform the conversion. Existing systems primarily focus on using a technique involving the copy and pasting of original content into a new URL address, to be viewed on smaller screens. However, no updates or changes made to the original website will be reflected on the new website because they are different, and are stored separately. This requires constant updating. Existing systems do not prompt the users with an option to build a mobile site from scratch if the website inputted is not in compliance with W3/CSS3 standards (standards for Cascading Style Sheets 3, provided by the World Wide Web Consortium). In a rapidly growing mobile smartphone market, consumers do not currently have a solution/tool that can automatically convert their websites to be mobile friendly format. Manual mobile smartphone website conversions are used for lack of better solutions.

It would be desirable to have a system to convert an existing website to a mobile compatible website at the time the website is accessed.

### SUMMARY OF THE INVENTION

In one aspect of the present invention, a system for providing a website to a mobile device includes a size identification module that identifies a desired mobile display size which is suitable for the mobile device; a website identification interface that identifies an original website having an original display size that is larger than the desired mobile display size; a website retrieval interface that retrieves an original content of the original website; a parsing module that parses the original content to identify website elements to be resized; a resizing module that provides a mobile content having resized elements that correspond to the elements-to-be-resized and which are adapted for display utilizing the desired mobile display size; a website generation module that generates a second website having the mobile content; and a website serving interface that provides the second website to the mobile device.

In another aspect of the present invention, a system for providing a website to a mobile device includes a size identification module that identifies a desired mobile display size which is suitable for the mobile device; a website identification interface for a user to provide a uniform resource locator (URL) to identify an original website having an original display size that is larger than the desired mobile display size; a website retrieval interface that retrieves an original content of the original website utilizing the URL; a parsing module that parses the original content to identify website elements to be resized, website elements to be reformatted for display on the mobile device, and website elements that are not to be resized or reformatted; a resizing-and-formatting module that provides a mobile content by combining resized elements that correspond to the elements-to-be-resized, reformatted elements corresponding to the elements-to-be-reformatted, and unmodified elements that correspond to the elements-not-to-be-resized-or-reformatted; a website generation module that generates a second website having the mobile content; website code that, when inserted into the website, automatically redirects a mobile browser of the website to the second website; and a website serving interface that provides the second website to the mobile device.

In yet another aspect of the present invention, a method for providing a website to a mobile device includes identifying a desired mobile display size which is suitable for the mobile device; identifying an original website having an original display size that is larger than the desired mobile display size; retrieving an original content of the original website; parsing the original content to identify website elements to be resized; providing provide a mobile content having resized elements that correspond to the elements-to-be-resized and which are adapted for display utilizing the desired mobile display size; generating a second website having the mobile content; and providing the second website to the mobile device.

### BRIEF DESCRIPTION OF THE DRAWINGS

FIG. 1 is a flowchart of an embodiment of a Website Registration module according to the present invention;

FIG. 2 is a flowchart of an embodiment of a Browsing module according to the present invention; and

FIG. 3 is a flowchart of an embodiment of a Conversion module according to the embodiments of FIGS. 1 and 2.

### DETAILED DESCRIPTION

The preferred embodiment and other embodiments, which can be used in industry and include the best mode now known of carrying out the invention, are hereby described in detail with reference to the drawings. Further embodiments, features and advantages will become apparent from the ensuing description, or may be learned without undue experimentation. The figures are not necessarily drawn to scale, except where otherwise indicated. The following description of embodiments, even if phrased in terms of “the invention” or what the embodiment “is,” is not to be taken in a limiting sense, but describes the manner and process of making and using the invention. The coverage of this patent will be described in the claims. The order in which steps are listed in the claims does not necessarily indicate that the steps must be performed in that order.

Broadly, an embodiment of the present invention generally provides an online web application that automatically converts an existing website into a mobile compatible or mobile-friendly website optimized for mobile smartphones and other mobile devices.

An embodiment of a system requires little to no SQL-databases to support the mobile website because it is merely a line of code imbedded into the original website. Whenever the website is viewed on mobile devices, a Conversion module may be invoked. If the website is viewed on a full-sized computer or PC, the original website may be displayed without conversion. If appropriate, the conversion results may be cached and re-used by the server system or by the user's device.

Embodiments may resolve the need for manual conversion of a website to be displayed on mobile devices by automating the process of conversion. The end-user may enter the uniform resource locator (URL) or other identifier of their website(s) in the web application. The web application may convert the inputted website(s) automatically into a mobile compatible form. The compatible website is the original with a self adapting “lens” that resizes the content from the original to fit the screen of the specific mobile device from which the end-user is viewing the website. The conversion is a code specific and unique to each website that accomplishes this resizing of the site. If the conversion fails because the inputted website is not coded under W3/CSS3 standards, the user may be provided with a suggestion to build a mobile smartphone compatible site. If the conversion is successful, the end-users may enter their payment information and then be redirected to their control panel where they can manage all their account information and add more websites to be converted to their accounts. The user may manually add a JavaScript on the top of their HTML code to allow the automatic redirection to the mobile-friendly version of their site when the website is browsed through a mobile device. Embodiments allow access to the site from mobile devices which may include smartphones.

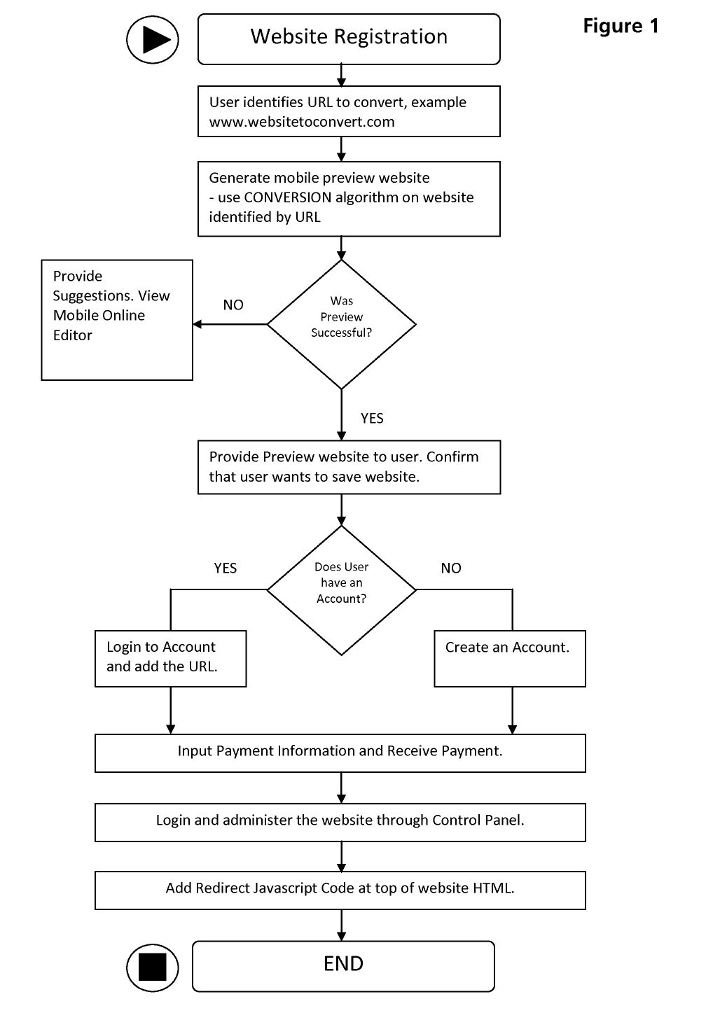

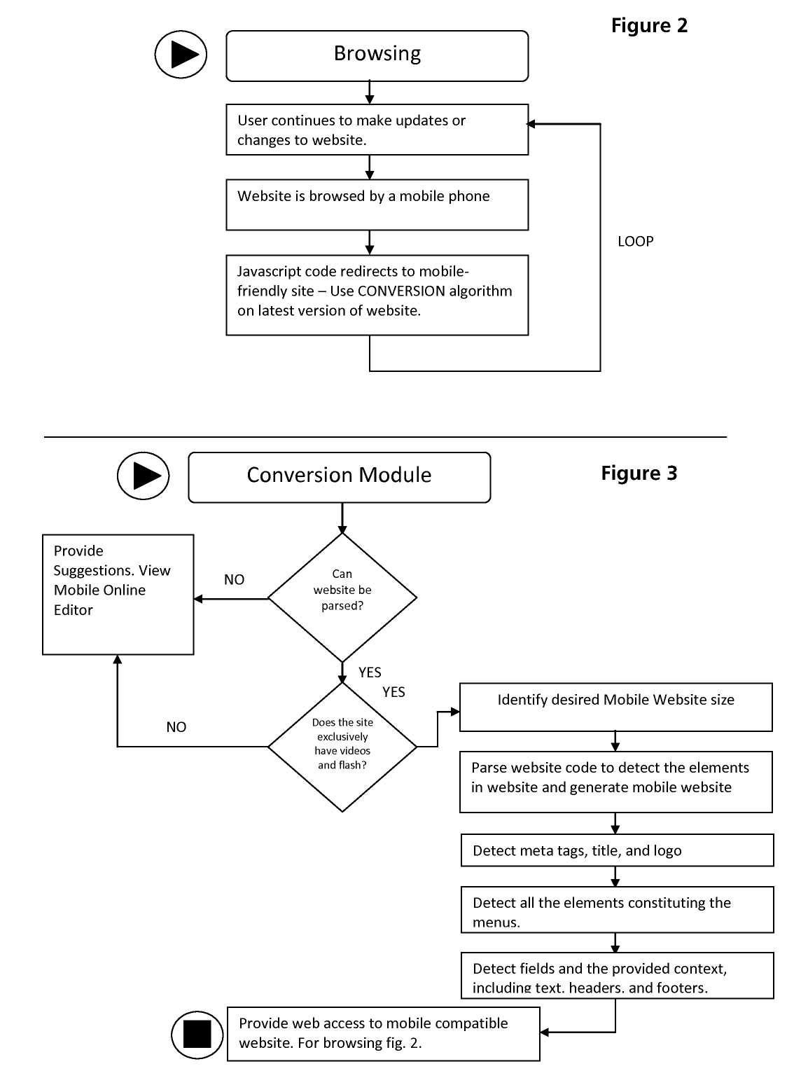

Embodiments of a system may include a module for Website Registration to be utilized by an end-user or client of the operators of the system, as depicted in FIG. 1. After this module is completed, the website may be browsed on mobile devices by web users as described in FIG. 2. These modules may utilize a Conversion module, which is described in FIG. 3.

As depicted in FIG. 1, an embodiment of a system may include a module for Website Registration.

An end-user, who may be a client, may identify a URL to convert, such as, for example, www.websitetoconvert.com, which is provided to a system according to the present invention, such as a computer server. The end-users may enter their current internet website URL in an input field on a website, and click on “convert”. The system may identify a desired mobile display size for the mobile device, either by automatic detection or data entry.

The system may use an embodiment of a Conversion module, as depicted in FIG. 3, on the identified website, to generate a mobile preview website. The system may use an interface to the web to gather and read the identified website, and convert the HTML and other code on the identified website to fit within the dimension and size of a mobile screen.

If generation of the mobile preview website was not successful, the system may provide suggestions to the end-user, or may present a mobile online editor to the end-user. If the conversion is not possible or not successful (i.e. because the website is not coded using W3/CSS3 standards), the end-users may be prompted with an option to create a mobile-compatible site from scratch. A “Do it yourself” tool may be presented that allows the end-user to build their mobile site from scratch.

The system may display the result of the converted site in a preview mode, which may from a mobile device or from a larger computer that is being used for website registration. The end-user may click on “Save” to save the conversion for mobile viewing.

The end-user may be prompted with account information. The end-users may create a new account if not a member, or the end-users may login into their current account and add the specified website to their account.

The system may receive payment. The end-users may be prompted with payment entry option. After payment, the end-users may receive an email notification along with a payment confirmation and be redirected to a control panel.

End-user information may be added to a database utilized by the system, which may be part of a computer which has interfaces to support web access.

The end-user may further administer the website. This may include support for a client to add/edit/update any information (text, image, menu, etc) to websites that have been created from scratch.

The end-user may add commands such as redirection JavaScript code at the top of the user's website HTML. End-users may add commands to invoke the Conversion module on the website to the user's website. The user may manually or automatically insert generated JavaScript code at the top of their website HTML code that may provide automatic redirection to a mobile-device compatible site.

As depicted in FIG. 2, an embodiment of a system may include a module for Browsing on mobile devices.

An end-user may continue to make updates or changes to the user's website. If the end-users update their website content, the changes may automatically be reflected on the mobile friendly website, and there may be no need to manually update the mobile version.

The user's website may be viewed and browsed by the end-user or by other web users who access the web utilizing a mobile phone or other mobile device. The end-user's website will be converted on-the-fly, at the time the website is accessed by mobile web users, into a mobile compatible website, if appropriate.

The user's website may have HTML and/or JavaScript commands that redirect or otherwise invoke the Conversion module to provide a mobile compatible website when the website is browsed through a mobile smartphone or other mobile device. The system may automatically generate and update the mobile friendly version utilizing the on latest version of the user's website on-the-fly.

FIG. 3 depicts an embodiment of a Conversion module. This module may be utilized to generate a mobile preview website, such as when an end-user is verifying to proceed with website registration of the user's website, or to generate a mobile compatible website, such as when mobile website user's access the user's website utilizing a mobile device such as a smartphone.

The system may verify that the identified website actually exists, and that it can be read and parsed by the system. If not, the Conversion module fails. The system may use a website standard, such as W3/CSS3, or other standards for websites.

The system may determine the type of the website to be converted. If the website is all video, such as Flash animation or MPEG video, or if for some other reason the website cannot be converted, then the system may direct an end-user to a “Do it yourself” tool that allows the end-user to build their mobile site from scratch.

The system may identify the desired mobile website size, which will depend upon the mobile device to be used. The mobile device may be that of an end-user, such as in preview mode, or that of a web user, such as by anyone using a mobile device to browse the user's website. The desired mobile size could be determined considering the height, width, resolution, settings, and other factors of a smartphone or other mobile device. This information could be provided by data entry from an end-user, or obtained from a smartphone or other device when the user's website is automatically redirected.

The system may parse the HTML and other website code to detect and evaluate the elements in the website. The system uses the HTML and other contents of the original website to generate a second, mobile site with a second set of mobile-friendly contents.

The system may detect the meta tags, the title of the website and the logo for the website. The logo of the website may be recreated on the fly based on the meta tags and what type of mobile device is accessing the site, so that the logo can substantially stretch across the screen of that type of mobile device.

The system may detect all the elements constituting the menus. Menus are adjusted to be displayed on the mobile site.

The system may detect fields that provide context to the website, including text, headers, and footers. The system readjusts the text and displays it using an algorithm to determine the importance. This may include weighting the importance of the title, and the fields identified as subheaders and/or footers.

The system may provide web access to the mobile compatible website. The converted website will combine the elements-to-be-resized with elements to be displayed without resizing, so that the generated website will have a desired mobile display size that is appropriate for the type of mobile device to be used. This may be a relatively small size, compared to the original website, since the original website may have been adapted or optimized for display utilizing an original display size that is larger than the desired mobile display size.

Embodiment of a system may include a manual to add the redirection script in the HTML Code of their existing website. This step may not be automated if the system provider does not have secure access to the end-users ftp/sftp account information. If the end-user enters this information, the provider could be able to automatically add that script into their code.

Embodiments may have a different order of the flow for the steps. For example, before showing a preview of the site, there may have been a step to create the account or login. Also, if the end-users are already logged in, the mobile preview website may be displayed within a personalized environment, may provide a control panel to the end-user, and may skip the stage of logging in after conversion (since the user is already logged in).

Embodiments may include a “deposit” option to allow active end-users to skip the payment stage when they add a domain to their panel. The amount will at that point be deducted from their deposit.

Embodiments may include a method for providing a mobile compatible website, comprising: identifying a website; inputting the identified website into a computer program; utilizing the computer program to convert the identified website to a mobile compatible website; and providing the mobile compatible website.

I claim:

1. A system for providing a website to a mobile device, comprising:
a size identification module that identifies a desired mobile display size which is suitable for the mobile device;
a website identification interface that identifies an original website having an original display size that is larger than the desired mobile display size;
a website retrieval interface that retrieves an original content of the original website;
a parsing module that parses the original content to identify website elements to be resized;
a resizing module that provides a mobile content having resized elements that correspond to the elements-to-be-resized and which are adapted for display utilizing the desired mobile display size;
a website generation module that generates a second website having the mobile content; and
a website serving interface that provides the second website to the mobile device.

2. The system of claim 1, wherein the original content further includes website elements to be reformatted for display on the mobile device and website elements that are not to be resized or reformatted, and the mobile content is generated by combining the resized elements with reformatted elements corresponding to the elements-to-be-reformatted and unmodified elements that correspond to the elements-not-to-be-resized-or-reformatted.

3. The system of claim 1, wherein a user provides a uniform resource locator (URL) to identify the original website and the original content of the original website is retrieved from the web utilizing the URL.

4. The system of claim 1, further comprising:
a suggestion module that, when the parsing module fails to parse the original content according to a website coding standard, provides a suggestion to a user that that suggests how the user may build a mobile compatible website.

5. The system of claim 1, further comprising:
website code that, when inserted into the website, automatically redirects a mobile browser of the website to the second website;
wherein, when the website serving interface provides the second website to the mobile device, the website generation module automatically utilizes the latest version of the website to create the second website.

6. The system of claim 1, wherein, when a logo is identified in the original content, a corresponding logo is resized in the mobile content to substantially stretch across the mobile screen.

7. The system of claim 1, wherein, when menus are identified in the original content, the display of corresponding menus in the mobile content is adjusted to be compatible with the mobile device.

8. The system of claim 1, wherein code elements of the original content, including titles, text, and meta tags, are utilized to resize text elements of the mobile content.

9. A system for providing a website to a mobile device, comprising:
a size identification module that identifies a desired mobile display size which is suitable for the mobile device;
a website identification interface for a user to provide a uniform resource locator (URL) to identify an original website having an original display size that is larger than the desired mobile display size;
a website retrieval interface that retrieves an original content of the original website utilizing the URL;
a parsing module that parses the original content to identify website elements to be resized, website elements to be reformatted for display on the mobile device, and website elements that are not to be resized or reformatted;
a resizing-and-formatting module that provides a mobile content by combining resized elements that correspond to the elements-to-be-resized, reformatted elements corresponding to the elements-to-be-reformatted, and unmodified elements that correspond to the elements-not-to-be-resized-or-reformatted;
a website generation module that generates a second website having the mobile content;
website code that, when inserted into the website, automatically redirects a mobile browser of the website to the second website; and
a website serving interface that provides the second website to the mobile device.

10. The system of claim 9, wherein:
when a logo is identified in the original content, a corresponding logo is resized in the mobile content to substantially stretch across the mobile screen;
when menus are identified in the original content, the display of corresponding menus in the mobile content is adjusted to be compatible with the mobile device; and
code elements of the original content, including titles, text, and meta tags, are utilized to resize text elements of the mobile content.

11. A method for providing a website to a mobile device, comprising:
identifying a desired mobile display size which is suitable for the mobile device;
identifying an original website having an original display size that is larger than the desired mobile display size;
retrieving an original content of the original website;
parsing the original content to identify website elements to be resized;
providing provide a mobile content having resized elements that correspond to the elements-to-be-resized and which are adapted for display utilizing the desired mobile display size;
generating a second web site having the mobile content; and
providing the second website to the mobile device.

12. The method of claim 11, further comprising:
automatically redirecting a mobile browser of the website to the second website; and
utilizing the latest version of the website to create the second website when the mobile browser is redirected.

13. The method of claim 11, further comprising:
identifying a logo in the first content; and
resizing a corresponding logo in the second content to substantially stretch across the mobile screen.

14. The method of claim 11, further comprising:
identifying menus in the first content; and
adjusting the display of corresponding menus in the second content to be compatible with the mobile device.

15. The method of claim 1, further comprising:
utilizing code elements of the first content, including titles, text, and meta tags, to resize text elements of the second content.
